(19) United States
(12) Patent Application Publication
(10) Pub. No.: US 2009/0051781 A1
(43) Pub. Date: Feb. 26, 2009

(54) Image processing apparatus, method, and program

(75) Inventors: Kazuhiko TAKEMURA, Asaka-shi (JP); Atsuhiko ISHIHARA, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/289,141

(22) Filed: Oct. 21, 2008

Related U.S. Application Data
(62) Division of application No. 10/774,566, filed on Feb. 10, 2004.

(30) Foreign Application Priority Data
Feb. 14, 2003 (JP) 2003-036959

(51) Int. Cl. H04N 5/228

(52) U.S. Cl. 348/222.1; 348/E05.031

(57) ABSTRACT

A CCD including primary photosensitive pixels that have a narrower dynamic range and secondary photosensitive pixels that have a wider dynamic range is used to obtain first image information from the primary photosensitive pixels and second image information from the secondary photosensitive pixels at one exposure, then the first image information and the second image information are stored as two separate files having names associated with each other. A user can select through a predetermined user interface whether or not the second image information should be stored and a dynamic range for the second image information. The dynamic range information for the second image information is stored in the file of the first image information and/or the header of the file of the second image information.

The present Application is a Divisional Application of U.S. patent application Ser. No. 10/774,566, filed on Feb. 10, 2004.

### BACKGROUND OF THE INVENTION

1. Field of the Invention

The present invention relates to an image processing apparatus and method and, in particular, to an apparatus and method for storing and reproducing images in a digital input device and to a computer program that implements the apparatus and the method.

2. Description of the Related Art

An image processing apparatus disclosed in Japanese Patent Application Publication No. 8-256303 is characterized in that it creates a standard image and a non-standard image from multiple pieces of image data captured by shooting the same subject multiple times with different amounts of light exposure, determines a region of the non-standard image that is required for expanding dynamic range, and compresses and stores that region.

U.S. Pat. No. 6,282,311, No. 6,282,312, and No. 6,282,313 propose methods of storing extended color reproduction gamut information in order to accomplish image reproduction in a color space having a color reproduction gamut larger than a standard color space represented by an sRGB. In particular, a difference between limited color gamut digital image data that has color values in a color space having the limited color gamut and an extended color gamut digital image having color values outside the limited color gamut is associated and stored with the limited color gamut digital image data.

In typical digital still cameras, tone scales are designed on the basis of photoelectric transfer characteristics specified in CCIR Rec709. According to this, image design is performed so as to provide a good image when it is reproduced in an sRGB color space, which is a de facto standard color space on a display for a personal computer (PC).

In real scene, luminance ranges vary from for example 1:100 to 1:10000 or more, for example, depending on weather or whether it is daytime/nighttime. Conventional CCD image pickup devices cannot capture information in such a wide luminance range at a time. Therefore, automatic exposure (AE) control is used to choose an optimum luminance range, the range is converted into electric signals according to predetermined photoelectric transfer characteristics, and an image is reproduced on a display such as a CRT. Alternatively, a wide dynamic range is provided by capturing multiple images of the same subject with different exposures as disclosed in Japanese Patent Application Publication No. 8-256303. However, this approach to taking multiple exposures can be applied only to shooting a still object.

When images of a special subject such as a bridal dress (white wedding dress) or a car with a metallic luster is captured or when a subject is shot in special conditions such as close-up shooting with flash or backlight shooting, it is difficult to choose exposure proper to a main subject and a high-quality image that covers a wide luminance range cannot be obtained. For such a scene, a better image can often be provided using a system for correcting the captured image later (during a printing process). The captured image is recorded in a wider dynamic range and an optimum image is generated during printing based on the recorded image information.

However, there is a problem that an adequate picture quality cannot be obtained from image information in a limited dynamic range in the state of the art.

### SUMMARY OF THE INVENTION

The present invention has been made in light of these circumstances and provides an image processing apparatus, method, and program that can generate an optimum image by image processing based on information obtained through image capturing in a wider dynamic range as required in a special application such as printing in desktop publishing whereas displaying an image in a given dynamic range during normal output on a device such as a PC.

In order to achieve the object, an image processing apparatus according to the present invention is characterized by including: an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from the primary photosensitive pixels and the secondary photosensitive pixels at one exposure; an information storage which stores first image information obtained from the primary photosensitive pixels and second image information obtained from the secondary photosensitive pixels; a selection device for selecting whether or not the second image information is to be stored; and a storage control device that controls storing of the first image information and the second image information according to selection performed with the selection device.

The image pickup device used in the present invention has a structure in which primary photosensitive pixels and secondary photosensitive pixels are combined. The primary photosensitive pixel and the secondary photosensitive pixel can obtain information having the same optical phase. Accordingly, two types of image information having different dynamic ranges can be obtained at one exposure. A user determines whether or not second image information having a wider dynamic range is required to be stored and makes this selection through a predetermined user interface. For example, if the user selects an option for not storing the second image information, the apparatus enters a storage mode in which only first image information is stored without performing a process for storing the second image information. On the other hand, if the user selects an option for storing the second image information, the apparatus enters a mode in which first and second image information are stored, and the first image information and second image information are stored. Thus, a good image can be provided that suits to a photographed scene or the purpose for taking pictures.

According to one aspect of the present invention, the first image information and the second image information are stored as two separate files associated with each other.

During reproduction, the second image information stored as the associated file can be used to reproduce an image using an extended reproduction gamut as required.

According to another aspect of the present invention, the second image information is stored as difference data between the first image information and the second image information in a file separate from a file storing the first image information file. Storing the second image information as the difference information can reduce size of the file.

In another aspect of the present invention, the second image information may be compressed by compression technology different from that used for the first image information, thereby reducing the file size.

According to yet another aspect of the present invention, the configuration described above further includes a D range information storage for storing dynamic range information for the second image information with at least one of the first image information and the second image information.

Preferably, dynamic range information for the second image information (for example, information indicating what percentage of the dynamic range for the first image information should be recorded as the dynamic range for the second information) is stored in the first image information file and/or the second image information file as additional information. This allows image combination during image reproduction to be performed in a quick and efficient manner.

According to yet another aspect, the image processing apparatus further comprises a D range setting operation device for specifying a dynamic range for the second image information; and a D range changeable control device for changing a reproduction gamut for the second image information according to setting specified with the D range setting operation device.

Preferably, the dynamic range for recording can be set by a user that suits to a photographed scene or his/her intention in taking pictures.

An image processing apparatus according to another aspect of the present invention comprises: an image pickup device which has a structure in which a large number of photosensitive pixels having a narrower dynamic range and higher sensitivity and a large number of photosensitive pixels having a wider dynamic range and lower sensitivity are arranged in a given arrangement and image signals can be obtained from the primary photosensitive pixels and the secondary photosensitive pixels at one exposure; a first image signal processing device which generates first image information according to signals obtained from the primary photosensitive pixels with the purpose of outputting an image by a first output device; and a second image signal processing device which generates second image information according to signals obtained from the secondary photosensitive pixels with the purpose of outputting an image by a second output device different from the first output device.

In an implementation, gamma and encode characteristics for the first image information are set with the purpose of outputting the first image information on an sRGB-based display and gamma and encode characteristics for the second image information are set so as to suit to print output with a reproduction gamut wider than that of sRGB.

When the first image information for standard image output and the second image information for image output with an extended reproduction gamut are recorded, the second image information is preferably recorded with a bit depth deeper than that of the first image information so as to represent finer information than the first image information.

According to another aspect of the present invention, the image processing apparatus further comprises: a reproduction gamut setting operation device for specifying a reproduction gamut for the second image information; and a reproduction area changeable control device for changing the reproduction gamut for the second image information according to a setting specified with the reproduction gamut setting operation device. This allows a user to determine at his/her disposal a desired reproduction gamut (such as a luminance reproduction gamut and color reproduction gamut) for an image to be recorded.

An image processing apparatus according to yet another aspect of the present invention comprises: an image pickup device which has a structure in which a large number of photosensitive pixels having a narrower dynamic range and higher sensitivity and a large number of photosensitive pixels having a wider dynamic range and lower sensitivity are arranged in a given arrangement and image signals can be obtained from the primary photosensitive pixels and the secondary photosensitive pixels at one exposure; a storage control device which controls storing of first image information obtained from the primary photosensitive pixels and the second image information obtained from the secondary photosensitive pixels; a D range setting operation device for specifying a dynamic range for the second image information; and a D range changeable control device which changes a reproduction luminance gamut for the second image information according to a setting specified with the D range setting operation device.

An image processing apparatus according to the invention comprises: an image display device for displaying an image obtained by an image pickup device which has a structure in which a large number of photosensitive pixels having a wider dynamic range and a large number of photosensitive pixels having a narrower dynamic range are arranged in a given arrangement and image signals can be obtained from the primary photosensitive pixels and the secondary photosensitive pixels at one exposure; and a display control device for switching between first image information obtained from the primary photosensitive pixels and second image information obtained from the secondary photosensitive pixels to cause the image display device to display the first or second image information.

A user can switch between the display of a first image (for example a standard reproduction gamut image) generated from the first image information and the display of a second image (for example an extended reproduction gamut image) generated from the second image information on the display unit as required to see the difference between the first and second images on the display screen.

Preferably, the display images are generated with different gammas so that both images of a photographed main subject have substantially the same brightness.

An image processing apparatus according to another aspect of the present invention comprises: an image display device for displaying an image obtained by an image pickup device which has a structure in which a large number of photosensitive pixels having a narrower dynamic range and higher sensitivity and a large number of photosensitive pixels having a wider dynamic range and lower sensitivity are arranged in a given arrangement and image signals can be obtained from the primary photosensitive pixels and the secondary photosensitive pixels at one exposure; and a display control device which causes the image display device to display first image information obtained from the primary photosensitive pixels and highlight an image portion the reproduction gamut of which is extended by the second image information with respect to the reproduction gamut of the first image information, on the display screen of the first image information.

The first image information is displayed on the image display device and determination is made as to whether there is a difference in the first image information from the second image information and, if so, the different portion is highlighted by flashing it, enclosing it with a line, or displaying it in a different brightness (tone) or color.

The image pickup device in the image processing apparatus of the present invention has a structure in which each photoreceptor cell is divided into a plurality of photoreceptor regions including at least the primary photosensitive pixel and the secondary photosensitive pixel, a color filter of the same color component is disposed over each photoreceptor cell for the primary photosensitive pixel and the secondary photosensitive pixel in the photoreceptor cell, and one micro-lens is provided for each photoreceptor cell.

The image pickup device can treat the primary photosensitive pixel and the secondary photosensitive pixel in the same photoreceptor cell (pixel cell) as being in virtually the same position. Therefore, the two pieces of image information which are temporally in the same phase and spatially in virtually the same position can be captured in one exposure.

The image processing apparatus of the present invention can be included in an electronic camera such as a digital camera and video camera or can be implemented by a computer. A program for causing a computer to implement the components making up the image processing apparatus described above can be stored in a CD-ROM, magnetic disk, or other storage media. The program can be provided to a third party through the storage medium or can be provided through a download service over a communication network such as the Internet.

As has been described, according to the present invention, first image information obtained from primary photosensitive pixels having a narrower dynamic range and second image information obtained from secondary photosensitive pixels having wider dynamic range can be recorded so that a user can select whether or not the second image information should be recorded. Therefore, good images can be provided that suit to photographed scenes or the purpose for taking pictures.

Furthermore, according to the present invention, a D range setting operation device is provided for specifying a dynamic range for the second image information so that the reproduction gamut for the second image information can be changed according to the setting specified through the D range setting operation device. Thus, a user him/herself can select a dynamic range for recording that suits to photographed scenes or his/her intention in taking pictures.

Moreover, image combination during image reproduction can be performed in a quick and efficient manner because dynamic range information for the second image information is in a file containing the first image information and/or a file containing the second image information.

### BRIEF DESCRIPTION OF THE DRAWINGS

FIG. 1 is a plan view showing an exemplary structure of the photoreceptor surface of a CCD image pickup device used in an electronic camera to which the present invention is applied;

FIG. 2 is a cross-sectional view along line 2-2 in FIG. 1;

FIG. 3 is a cross-sectional view along line 3-3 in FIG. 1;

FIG. 4 is a schematic plan view showing the entire structure of the CCD shown in FIG. 1;

FIG. 5 is a plan view showing another exemplary structure of a CCD;

FIG. 6 is a cross-sectional view along line 6-6 in FIG. 5;

FIG. 7 is a plan view showing yet another exemplary structure of a CCD;

FIG. 8 is a graph of the photoelectric transfer characteristics of a primary photosensitive pixel and a secondary photosensitive pixel;

FIG. 9 is a block diagram showing a configuration of an electronic camera according to an embodiment of the present invention;

FIG. 10 is a block diagram showing details of a signal processing unit shown in FIG. 9;

FIG. 11 is a graph of photoelectric transfer characteristics for the sRGB color space;

FIG. 12 shows examples of an sRGB color space and an extended color space;

FIG. 13 is a diagram showing an encode expression for an sRGB color reproduction gamut and an encode expression for an extended reproduction color gamut;

FIG. 14 shows an example of a directory (folder) structure of a storage medium;

FIG. 15 is a block diagram showing an exemplary implementation for recording low-sensitivity image data as a difference image;

FIG. 16 is a block diagram showing a configuration of a reproduction system;

FIG. 17 is a graph of the relationship between the level of a final image (compound image data) generated by combining high-sensitivity image data and low-sensitivity image data and the relative luminance of a subject;

FIG. 18 shows an example of a user interface for selecting a dynamic range;

FIG. 19 shows an example of a user interface for selecting a dynamic range;

FIG. 20 is a flowchart of a procedure for controlling a camera of the present invention;

FIG. 21 is a flowchart of a procedure for controlling the camera of the present invention;

FIG. 22 is a flowchart of a procedure for controlling the camera of the present invention; and

FIG. 23 shows an example of a displayed image provided by wide dynamic range shooting.

### DETAILED DESCRIPTION OF THE PREFERRED EMBODIMENTS

Preferred embodiments of the present invention will be described below in detail with respect to the accompanying drawing.

### [Structure of Image Pickup Device]

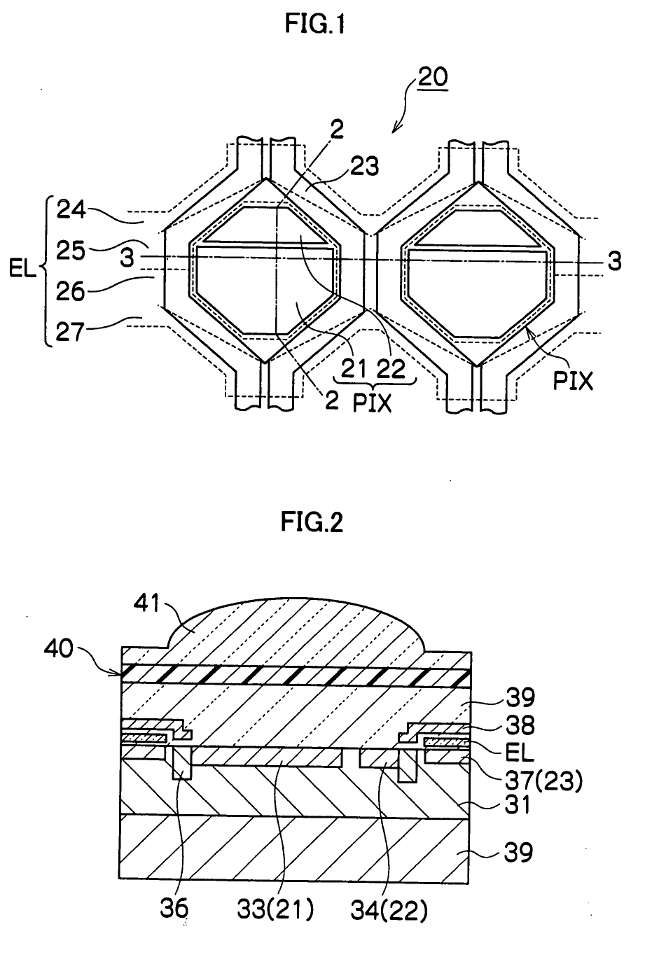

A structure of an image pickup device for wide-dynamic-range imaging used in an electronic camera to which the present invention is applied will be described first. FIG. 1 is a plan view of an exemplary structure of the photoreceptor surface of a CCD 20. While two photoreceptor cells (pixels: PIX) are shown side by side in FIG. 1, a large number of pixels (PIX) are arranged horizontally (in rows) and vertically (in columns) in predetermined array cycles.

Each pixel PIX includes two photodiode regions 21 and 22 having different sensitivities. A first photodiode region 21 has a larger area and forms a primary photosensor (hereinafter referred to as a primary photosensitive pixel). A second photodiode region 22 has a smaller area and forms a secondary photosensor (hereinafter referred to as a secondary pixel). A vertical transmission channel (VCCD) 23 is formed to the right of a pixel PIX.

The pixel array shown in FIG. 1 has a honeycomb structure, in which pixels, not shown, are disposed above and below the two pixels PIX shown in such a manner that they are horizontally staggered by half a pitch from the pixels shown. The VCCD 23 shown on the left of each pixel shown in FIG. 1 is used to read an electrical charge from a pixel, not shown, disposed above and below the pixels PIX shown and transfer the charge.

As indicated by dashed lines in FIG. 1, transfer electrodes 24, 25, 26, and 27 (collectively indicated by EL) required for four-phase drive (φ1, φ2, φ3, φ4) are disposed above the VCCD 23. For example, if the transfer electrodes are formed by two polysilicon layers, the first transfer electrode 24 to which a pulse voltage of φ1 is applied and the third transfer electrode 26 to which a pulse voltage of φ3 is applied are formed by a first polysilicon layer and the second transfer electrode 25 to which a pulse voltage of φ2 is applied and the fourth transfer electrode 27 to which a pulse voltage of φ4 is applied are formed by a second polysilicon layer. The transfer electrode 24 also controls a charge read-out from the secondary photosensitive pixel 22 to the VCCD 23. The transfer electrode 25 also controls a charge read-out from the primary photosensitive pixel 21 to the VCCD 23.

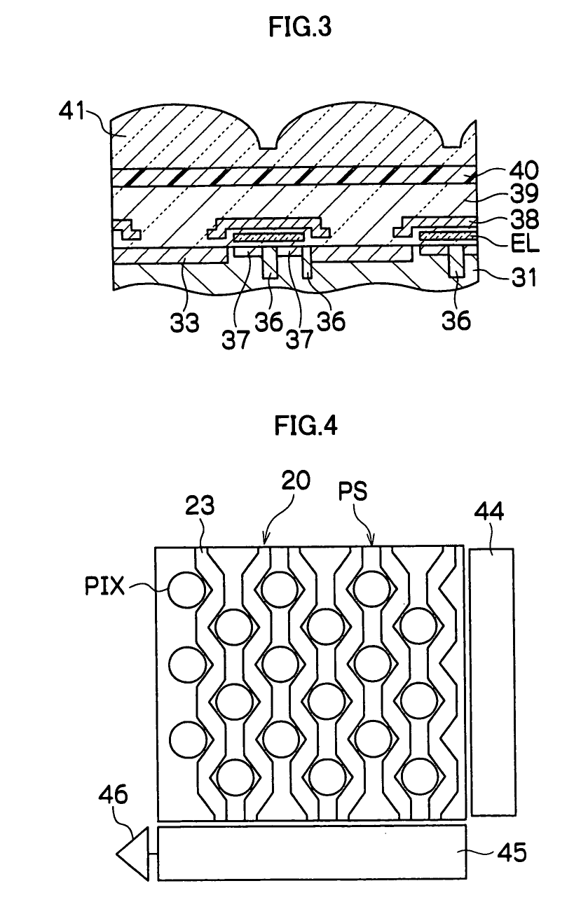

FIG. 2 is a cross-sectional view along line 2-2 in FIG. 1. FIG. 3 is a cross-sectional view along line 3-3 in FIG. 1. As shown in FIG. 2, a p-type well 31 is formed on one surface of an n-type semiconductor substrate 30. Two n-type regions 33, 34 are formed in surface areas of the p-type well 31 to provide photodiodes. The photodiode in the n-type region designated by reference numeral 33 corresponds to the primary photosensitive pixel 21 and the photodiode in the n-type region designated by reference numeral 34 corresponds to the secondary photosensitive pixel 22. A p⁺ region 36 is a channel stop region that provides electrical separation between pixels PIX and VCCDs 23.

As shown in FIG. 3, provided in the vicinity of the photodiode n-type region 33 is an n-type region 37 that forms a VCCD 23. The p-type well 31 between the n-type regions 33 and 37 forms a read-out transistor.

Provided on the surface of the semiconductor substrate is an insulating layer of silicon oxide film, on which a transfer electrode EL of polysilicon is provided. The transfer electrode EL is provided over the VCCD 23. A further insulating layer of silicon oxide film is formed on top of the transfer electrode EL, on which provided is a light shielding film 38 of a material such as tungsten that covers components such as the VCCD 23 and has an opening over the photodiode.

Formed over the light shielding film 38 is an interlayer insulating film 39 made of glass such as phosphosilicate the surface of which is planarized. A color filter layer (on-chip color filter) 40 is provided on the interlayer insulating film 39. The color filter layer 40 may include three or more color regions such as red, green, and blue regions and one of the color regions is assigned to each pixel PIX.

A micro-lens (on-chip micro-lens) 41 made of a material such as resist material is provided on the color filter layer 40 correspondingly to each pixel PIX. One micro-lens 41 is provided over each pixel PIX and has the capability of causing light incident from above to converge at the opening defined by the light shielding film 38.

The light incident through the micro-lens 41 undergoes color separation by the color filter layer 40 and reaches each of the photodiode regions of the primary photosensitive pixel 21 and the secondary photosensitive pixel 22. The light incident into the photodiode regions is converted into signal charges in accordance with the amount of the light and the signal charges are separately read out to the VCCDs 23.

In this way, two image signals having different sensitivities (a high-sensitivity image signal and a low-sensitivity image signal) can be obtained from one pixel PIX separately from each other. The image signals thus obtained have the same optical phase.

FIG. 4 shows an arrangement of pixels PIX and VCCDs 23 in a photoreceptor region PS of the CCD 20. The pixels PIX are arranged in a honeycomb structure in which the geometrical center of each cell is staggered by half a pixel pitch (½ pitch) in both row and column directions. That is, one of adjacent rows (or columns) of pixels PIX is staggered by substantially ½ of an array interval in the row (or column) direction from the other row (or column).

In FIG. 4, provided to the right of a photoreceptor region PS in which pixels PIX are disposed is a VCCD driver circuit 44 for applying a pulse voltage to a transfer electrode EL. Each pixel PIX includes the primary photosensitive pixel 21 and the secondary photosensitive pixel 22 as described above. Each VCCD 23 is provided close to each column in a meandering manner.

Provided below the photoreceptor regions PS (at the lower end of the VCCDs 23) is a horizontal transfer channel (HCCD) 45 for horizontally transferring signal charges provided from the VCCDs 23.

The HCCD 45 is formed by a two-phase drive transfer CCD. The tail end (the left most end in FIG. 4) of the HCCD 45 is coupled to an output portion 46. The output portion 46 includes an output amplifier, detects a signal charge inputted into it, and outputs the charge as a signal voltage to an output terminal. In this way, signals photoelectric-converted at the pixels PIX are outputted as a dot-sequential string of signals.

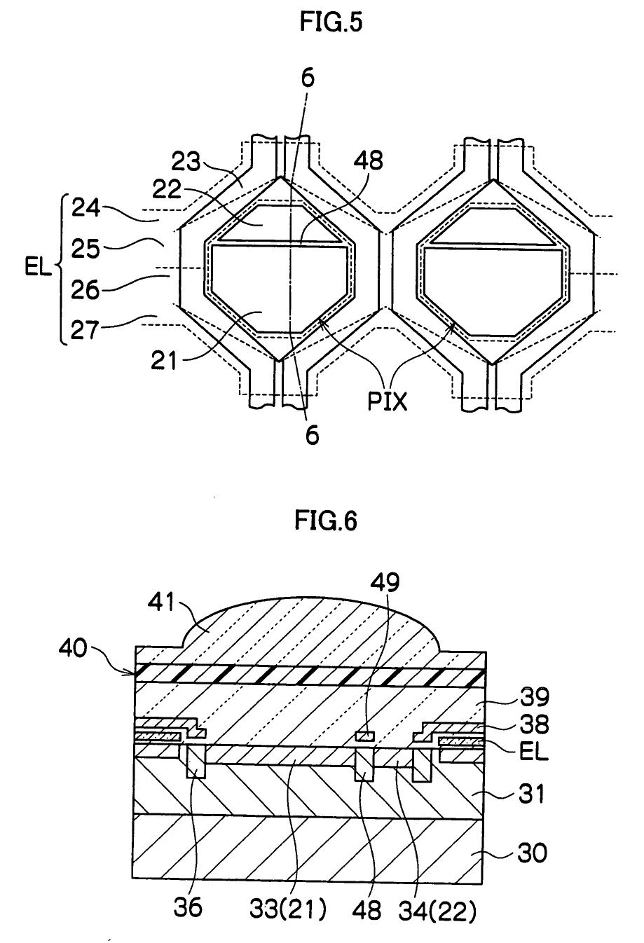

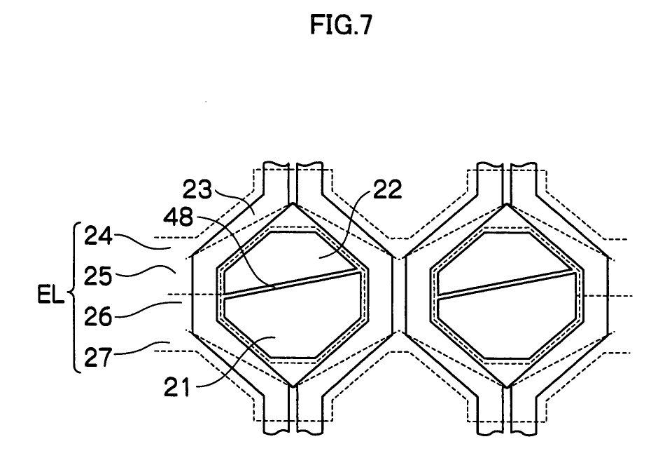

FIG. 5 shows another exemplary structure of a CCD 20. FIG. 5 is a plan view and FIG. 6 is a cross-sectional view along line 6-6 in FIG. 5. The same or similar elements in the FIGS. 5 and 6 as those shown in FIGS. 1 and 2 are labeled with the same reference numerals and the description of which will be omitted.

As shown in FIGS. 5 and 6, a p⁺ separator 48 is provided between the primary photosensitive pixel 21 and the secondary photosensitive pixel 22. The separator 48 functions as a channel stop region (channel stopper) to provide electrical separation between the photodiode regions. A light shielding film 49 is provided over the separator 48 in the position coinciding with the separator 48.

The light shielding film 49 and the separator 48 allow incident light to be efficiently separated and prevent electrical charges accumulated in the primary photosensitive pixel 21 and secondary photosensitive pixel 22 from becoming mixed with each other. Other configurations are same as those shown in FIGS. 1 and 2.

The cell shape or opening shape of a pixel PIX is not limited to the one shown in FIGS. 1 and 5. It may take any shape such as a polygon or circle. Furthermore, the form of separation of each photoreceptor cell (split shape) is not limited to the one shown in FIGS. 1 and 5.

FIG. 7 shows yet another exemplary structure of a CCD 20. The same or similar elements in the FIG. 7 as those shown in FIGS. 1 and 5 are labeled with the same reference numerals and the description of which will be omitted. FIG. 7 shows a structure in which two photosensors (21, 22) are separated by an oblique separator 48.

Any split shape, number of split parts, and area ratio of each cell may be chosen as appropriate, provided that electrical charges accumulated in each split photosensitive area can be read out into a vertical transmission channel. However, the area of a secondary photosensitive pixel must be smaller than that of a primary photosensitive pixel. Preferably, reduction in the area of a primary photosensor is minimized in order to minimize reduction in sensitivity.

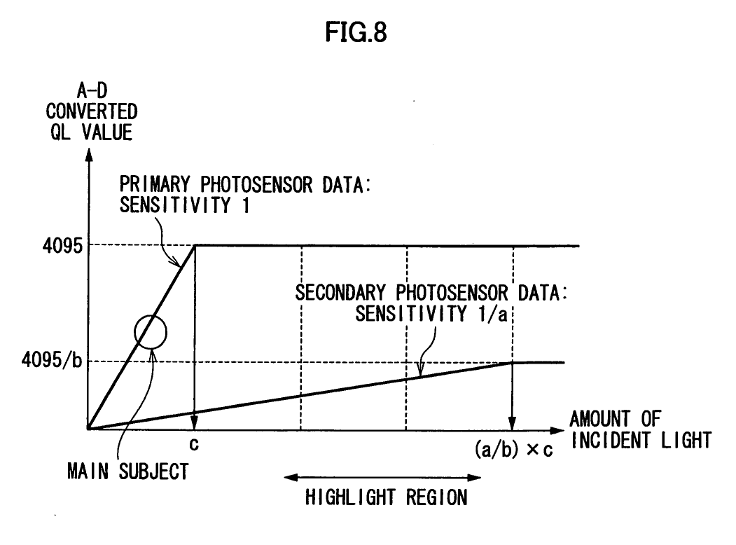

FIG. 8 is a graph of the photoelectric transfer characteristics of the primary photosensitive pixel 21 and the secondary photosensitive pixel 22. The horizontal axis indicates the amount of incident light and the vertical axis indicates image data values (QL value) after A-D conversion. While 12-bit data is used in this example for purpose of illustration, the number of bits is not limited to this.

As shown in FIG. 8, the ratio of the sensitivity of the primary photosensitive pixel 21 to that of the secondary photosensitive pixel 22 is 1:1/a (where, a>1 and, in this example, a=16). The output of the primary photosensitive pixel 21 gradually increases in proportion to the amount of incident light and reaches the saturation value (QL value=4,095) when the amount of incident light is “c.” Then, the output of the primary photosensitive pixel 21 remains constant even though the amount of incident light increases. Hereinafter “c” is called the saturation amount of light of the primary photosensitive pixel 21.

The sensitivity of the secondary photosensitive pixel 22 is 1/a of that of the primary photosensitive pixel 21 and becomes saturated at a QL value of 4,095/b when the amount of incident light is α×c (where, b>1, α=a/b and, in this example, b=4 and α=4). Hereinafter, the value “α×c” is called the saturation amount of light of the secondary photosensitive pixel 22.

Combining the primary photosensitive pixel 21 and the secondary photosensitive pixel 22 that have different sensitivities and saturation values as described above can increase the dynamic range of the CCD 20 by a factor of a compared with a structure that includes the primary photosensitive pixel alone. In this example, the sensitivity ratio is 1/16 and the saturation ratio is 1/4, therefore the dynamic range is increased by a factor of about 4. Assuming that the maximum dynamic range in the case of using the primary photosensitive pixel only is 100%, the maximum dynamic range is increased by about 400% in this example by using the secondary photosensitive pixel in addition to the primary one.

As described earlier, in an image pickup device such as a CCD, light received by a photodiode is passed through RGB or C (cyan), M (magenta), and Y (yellow) color filters to convert it into signals as described above. The amount of light that can provide a signal depends on the sensitivities of an optical system, including lenses, and a CCD sensitivity and the saturations. Compared with a device that has a higher sensitivity but can hold a smaller amount of electrical charge, a device that has a lower sensitivity but can hold a larger amount of electrical charge can provide an appropriate signal even if the intensity of incident light is high, and provide a wider dynamic range.

Implementations for setting responses to the intensity of light include: (1) adjusting the amount of incident light into a photodiode and (2) changing the amplifier gain of a source follower that receives light and converts it into a voltage. In the case of item (1), the amount of light can be adjusted by using the optical transmission characteristics and relative positions of micro-lenses disposed over the photodiode. The amount of charge that can be held is determined by the size of the photodiode. Arranging the two photodiodes (21, 22) of different sizes as described with respect to FIGS. 1 to 7 can provide signals that can respond to different light contrasts. In addition, an image pickup device (CCD 20) having a wide dynamic range can ultimately be implemented by adjusting the sensitivities of the two photodiodes (21, 22).

### [Example of Camera Capable of Capturing Images in Wide Dynamic Range]

An electronic camera containing a CCD for capturing images in a wide dynamic range as described above will be described below.

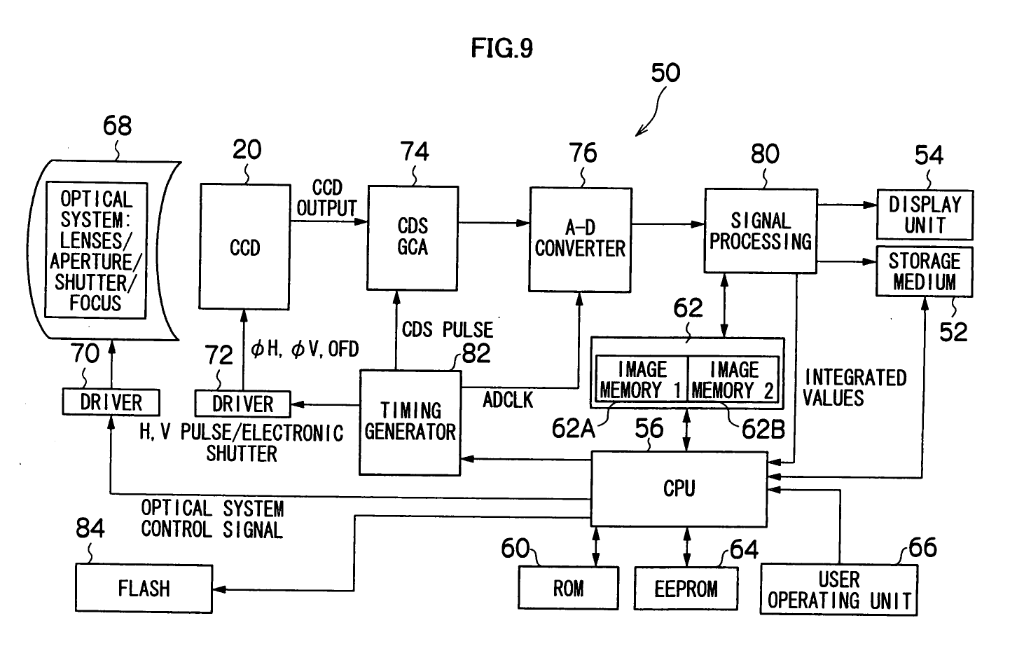

FIG. 9 is a block diagram showing a configuration of an electronic camera according to an embodiment of the present invention. The camera 50 is a digital camera that captures an optical image of a subject through a CCD 20, converts it into digital image data, and stores the data in a storage medium 52. The camera 50 includes a display unit 54 and can display an image that is being shot or an image reproduced from stored image data on the display unit 54.

Operations of the entire camera 50 are controlled by a central processing unit (CPU) 56 contained in the camera 50. The CPU 56 functions as a controller that controls the camera system according to a given program and also functions as a processor that performs computations such as automatic exposure (AE) computations, automatic focusing (AF) computations, and automatic white balancing (AWB) control.

The CPU 56 is connected with a ROM 60 and a memory (RAM) 62 over a bus, which is not shown. The ROM 60 contains data required for the CPU 56 to execute programs and perform control. The memory 62 is used as a development space for the program and a workspace for the CPU 56 and as temporary storage areas for image data.

The memory 62 has a first area (hereinafter called the first image memory) 62A for storing image data mainly obtained from primary photosensitive pixels 21 and a second area (hereinafter called the second image memory) 62B for storing image data mainly obtained from secondary photosensitive pixels 22.

Also connected to the CPU 56 is an EEPROM 64. The EEPROM 64 is a non-volatile memory device for storing information about defective pixels of the CCD 20, data required for controlling AE, AF, and AWB, and other processing, and customization information set by a user. The EEPROM 64 is rewritable as required and does not lose information when power is shut off from it. The CPU 56 refers to data in the EEPROM 64 as needed to perform operations.

A user operating unit 66 is provided on the camera 50 through which a user enters instructions. The user operating unit 66 includes various operating components such as a shutter button, a zoom switch, and a mode selector switch. The shutter button is an operating device with which the user provides an instruction to start to take a picture and is configured as a two-stroke switch having an S1 that is turned on when the button is pressed halfway and an S2 switch that is turned on when the button is pressed all the way. When S1 is turned on, AE and AF processing is performed. When S2 is turned on, an exposure for recording is started. The zoom switch is an operating device for changing shooting magnification power or reproduction magnification power. The mode selector switch is an operating device for switching between shooting mode and reproduction mode.

The user operating unit 66 also includes a shooting mode setting device for setting an operation mode (for example, continuous shooting mode, automatic shooting mode, manual shooting mode, portrait mode, landscape mode, and night view mode) suitable for the purpose for taking a picture, a menu button for displaying a menu panel on the display unit 54, an arrow pad (cursor moving device) for choosing a desired option from the menu panel, an OK button for confirming a choice or directing the camera to perform an operation, a cancel button for clearing a choice or canceling a direction or providing an undo instruction to restore the camera to the previous state, a display button for turning on or off the display unit 54 or switching between display methods, switching between display/non-display of an on-screen-display (OSD), and D range extension mode switch for specifying whether or not a dynamic range extending process (making a compound image) is performed.

The user operating unit 66 also includes components provided by a user interface, such as one by choosing a desired option from the menu panel, in addition to such components as push-button switches, dials, lever switches.

A signal from the user operating unit 66 is provided to the CPU 56. The CPU 56 controls circuits in the camera 50 according to the input signal from the user operating unit 66. For example, it controls and drives lenses, controls shooting operations, charge reading out from the CCD 20, image processing, recording/reproducing of image data, manages files in the storage medium 52, and controls display on the display unit 54.

The display unit 54 may be a color liquid-crystal display. Other types of displays (display devices) such as organic electroluminescence display may also be used. The display unit 54 can be used as an electronic viewfinder for seeing the angle of view in taking a picture as well as a device which reproduces and displays the recorded image. Moreover the display unit is used as a user interface display screen on which information such as a menu, options, and settings is displayed as required.

Shooting functions of the camera 50 will be described below.

The camera 50 includes an optical system unit 68 and a CCD 20. Any of other types of image pickup devices such as a MOS solid-state image pickup device may be used in place of the CCD 20. The optical system unit 68 includes a taking lens, not shown, and a mechanical shutter mechanism that also serves as an aperture. While the details of the optical configuration is not shown, the taking lens unit 68 consists of electric zoom lens and includes variable-power lenses which provides a set of magnification power changes (a variable focal length), a set of correcting lenses, and a focus lens for adjusting the focus.

When a user activates the zoom switch on the user operating unit 66, the CPU 56 outputs an optical system control signal to a motor driving circuit 70 according to the switch activation. The motor driving circuit 70 generates a signal for driving lenses according to the control signal from the CPU 56 and provides it to a zoom motor (not shown). A motor driving voltage outputted from the motor driving circuit 70 actuates the zoom motor to cause the variable-power lenses and the correcting lenses in the taking lens to move along the optical axis to change the focal length (optical zoom ratio) of the taking lens.

Light passing through the optical system unit 68 reaches the photoreceptor surface of the CCD 20. A large number of photosensors (photosensors) are disposed on the photoreceptor surface of the CCD 20 and red (R), green (G), and blue (B) primary color filters are disposed in a given array structure over the photosensors accordingly. In place of the RGB color filters, other color filters such as CMY color filters may be used.

An image of subject formed on the photoreceptor surface of the CCD 20 is converted into an amount of signal charge that corresponds to the amount of incident light by each photosensor. The CCD 20 has an electronic shutter capability for controlling the charge accumulation time (shutter speed) of each photosensor in accordance with timing of shutter gate pulses.

The signal charges accumulated in the photosensors of the CCD 20 are sequentially read out as voltage signals (image signals) corresponding to the signal charges, in accordance with pulses (horizontal drive pulses φH, vertical drive pulses φV, and overflow drain pulses) provided from a CCD driver 72. The image signals outputted from the CCD 20 are sent to an analog processing unit 74. The analog processing unit 74 includes a CDS (correlation double sampling) circuit and a GCA (gain control amplifier) circuit. Sampling, color separation into R, G, and B color signals, and adjustment of the signal level of each color signal are performed in the analog processing unit 74.

The image signals outputted from the analog processing unit 74 are converted into digital signals by an A-D converter 76 and then stored in the memory 62 through a signal processing unit 80. A timing generator (TG) 82 provides timing signals to the CCD driver 72, analog processing unit 74, and A-D converter 76 according to instructions from the CPU 56. The timing signals provide synchronization among the circuits.

The signal processing unit 80 is a digital signal processing block that also serves as a memory controller for controlling writes and reads to and from the memory 62. The signal processing unit 80 is an image processing device that includes an automatic calculator for performing AE/AF/AWB processing, a white balancing circuit, a gamma conversion circuit, a synchronization circuit (which interpolates spatial displacement of color signals due to color filter arrangements of the single-plate CCD and calculates a color at each dot), a luminance/color-difference signal luminance/color-difference-signal generation circuit, an edge correction circuit, a contrast correction circuit, a compression/decompression circuit, and a display signal generation circuit and processes image signals through the use of the memory 62 according to commands from the CPU 56.

Data stored (CCDRAW data) in the memory 62 is sent to the signal processing unit 80 through the bus. Details of the signal processing unit 80 will be described later. The image data sent to the signal processing unit 80 undergoes predetermined signal processing such as white balancing, gamma conversion, and a conversion process (YC process) in which data is converted into luminance signals (Y signals) and color-difference signals (Cr, Cb signals), and is then stored in the memory 62.

When a picture taken is output to the display unit 54, image data is read from the memory 62 and sent to a display conversion circuit of the signal processing unit 80. The image data sent to the display conversion circuit is converted into signals in a predetermined format for display (for example, NTSC-based composite color video signals) and then outputted onto the display unit 54. Image signals outputted from the CCD 20 periodically rewrite image data in the memory 62 and video signals generated from the image data are provided to the display unit 54, thus an image being taken (a camera-through image) on the display unit 54 in real time. The operator can check his or her view angle (composition) with the camera-through image presented on the display unit 54.

When the operator decides a view angle and presses the shutter button, the CPU 56 detects the depression. The CPU 56 performs preparatory operation for taking a picture, such as AE and AF processing, in response to a halfway depression of the shutter button (S1=ON) or starts CCD exposure and read-out control for capturing an image to be recorded in response to a full depression of the shutter button (S2=ON).

In particular, the CPU 56 performs calculations such as focus evaluation and AE calculations on the captured image data in response to S1=ON and sends control signals to the motor driving circuit 70 according to the results of the calculations to control an AF motor, which is not shown, to move the focus lens in the optical system unit 68 into the focusing position.

The AE calculator in the automatic calculator includes a circuit for dividing one picture of a captured image into a number of areas (for example, 8×8 areas) and integrating RGB signals in each area. The integrated value is provided to the CPU 56. The integrated value for each color of the RGB signals may be calculated or the integrated value for only one color (for example G signals) may be calculated.

The CPU 56 performs weighted addition based on the integrated value obtained from the AE calculator, detects the brightness of the photographed subject (subject luminance), and calculates an exposure value (shooting EV value) suitable for the shooting.

The AE of the camera 50 performs photometry more than one time to measure a wide luminance range precisely and determines the luminance of the photographed subject accurately. For example, if one photometric measurement can measure a range of 3 EV, up to four photometric measurements are performed under different exposure conditions in a range of 5 to 17 EV.

A photometric measurement is performed under a given exposure condition and the integrated value for each area is monitored. If there is a saturated area in the image, photometric measurements are performed under different conditions. On the other hand, if there is no saturated area in the image, then the photometric quantities can be measured correctly under that condition. Therefore, the exposure condition will not be changed.

By performing photometry more than once in this way, photometric quantities in a wide range (5 to 17 EV) are measured and an optimum exposure condition is determined. A range that can be measured or to be measured at one photometric measurement can be set for each model of camera as appropriate.

The CPU 56 controls the aperture and the shutter speed on the basis of the results of the AE calculations described above and captures an image to be recorded in response to S2=ON. The camera 50 in this example reads data only from the primary photosensitive pixels 21 during generation of a camera-through image and generates a camera-through image from the image signals of the primary photosensitive pixels 21. AE processing and AF processing associated with shutter button S1=ON are performed on the basis of signals obtained from the primary photosensitive pixels 21. If a wide dynamic range shooting mode has been selected by the operator, or if a wide dynamic range shooting mode is automatically selected because of a result of AE (ISO sensitivity or photometric quantity) or a white balance gain value, then exposure of the CCD 20 is performed in response to a shutter button S2=ON operation. After the exposure, the mechanical shutter is closed to block light from entering and charges are read from the primary photosensitive pixels 21 in synchronization with a vertical drive signal (VD), and then charges are read from the secondary photosensitive pixels 22.

The camera 50 has a flash device 84. The flash device 84 is a block including an electric discharge tube (for example a xenon tube) as its light emitter, a trigger circuit, a main capacitor storing energy to be discharged, and a charging circuit. The CPU 56 sends a command to the flash device 84 as required and controls light emission from the flash device 84.

Image data captured in response to a full depression of the shutter button (S2=ON) as described above undergoes YC processing and other appropriate processing in the signal processing unit 80, then is compressed according to a predetermined compression format (for example, JPEG), and stored in the storage medium 52 through media interface (not shown in FIG. 9). The compression format is not limited to JPEG. Any other format such as MPEG may be used.

The device for storing image data may be any of various types of media, including a semiconductor memory card such as SmartMedia™ and CompactFlash™, a magnetic disk, an optical disc, and a magneto-optical disc. It is not limited to a removable disk. It may be a storage medium (internal memory) contained in the camera 50.

When reproduction mode is selected through the mode selector switch in the user operating unit 66, the last image file stored in the storage medium 52 (the most recently stored file) is read out. The image file data read from the storage medium 52 is decompressed by the compression/decompression circuit in the signal processing unit 80, then converted into signals for display and outputted onto the display unit 54.

Forward or reverse frame-by-frame reproduction can be performed by manipulating the arrow pad while one frame is being reproduced in reproduction mode. The file of the next frame is read from the storage medium 52 and the display image is updated with the file.

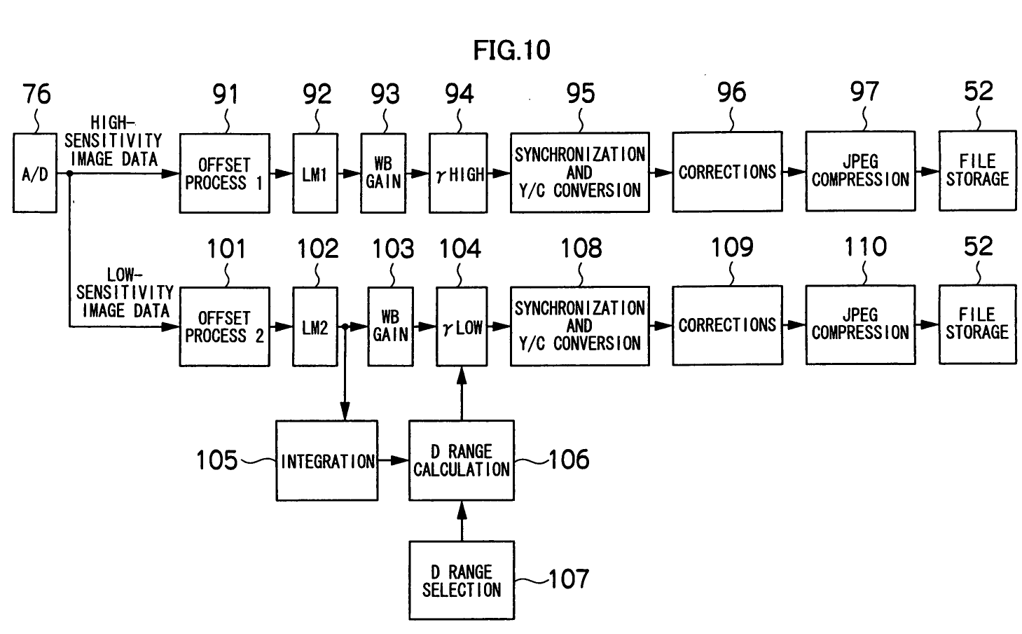

FIG. 10 is a block diagram showing a signal processing flow in the signal processing unit 80 shown in FIG. 9.

As shown in FIG. 10, primary photosensitive pixel data (called high-sensitivity image data) is converted into digital signals by the A-D converter 76. The digital signals are subjected to offset processing in an offset processing circuit 91. The offset processing circuit 91 corrects dark current components in a CCD output. It subtracts optical black (OB) signal values obtained from light-shielding pixels on the CCD 20 from pixel values. Data (high-sensitivity RAW data) outputted from the offset processing circuit 91 is sent to a linear matrix circuit 92.

The linear matrix circuit 92 is a color tone correction processor that corrects spectral characteristics of the CCD 20. Data corrected in the linear matrix circuit 92 is sent to a white balance (WB) gain adjustment circuit 93. The WB gain adjustment circuit 93 includes a variable gain amplifier for increasing or reducing the level of R, G, B signals and adjusts the gain of each color signal according to an instruction from the CPU 56. The signals after being white-balance adjusted in the WB gain adjustment circuit 93 are sent to a gamma correction circuit 94.

The gamma correction circuit 94 converts the input/output characteristics of the signals according to an instruction from the CPU 56 so that desired gamma characteristics are achieved. The image data after gamma correction at the gamma correction circuit 94 is sent to a synchronization circuit 95.

The synchronization circuit 95 includes a processing component for calculating the color (RGB) of each dot by interpolating spatial displacements of color signals due to color filter arrangements of the single-plate CCD and a YC conversion component for generating luminance (Y) signals and color-difference signals (Cr, Cb) from RGB signals. The luminance and color-difference signals (Y Cr Cb) generated in the synchronization circuit 95 is sent to correction circuits 96.

The correction circuits 96 may include an edge enhancement (aperture correction) circuit and a color correction circuit using a color-difference matrix. The image data to which required corrections have been applied in the correction circuits 96 is sent to a JPEG compression circuit 97. The image data compressed in the JPEG compression circuit 97 is stored in a storage medium 52 as an image file.

Likewise, secondary photosensitive pixel data (called low-sensitivity image data) converted into digital signals by the A-D converter 76 undergoes offset processing in an offset processing circuit 101. The data (low-sensitivity RAW data) outputted from the offset processing circuit 101 is sent to a linear matrix circuit 102.

The data output from the linear matrix circuit 102 is sent to a white balance (WB) gain adjustment circuit 103, where white balance adjustment is applied to the data. The signals after being white-balance adjusted is sent to a gamma correction circuit 104.

The low-sensitivity image data outputted from the low-sensitivity image data linear matrix circuit 102 is also provided to an integration circuit 105. The integration circuit 105 divides the captured image into a number of areas (for example 16×16 areas) and integrates R, G, and B pixel values in each area and calculates the average of the values for each color.

The maximum value of the G component (Gmax) is found from among the averages calculated in the integration circuit 105 and data representing the found Gmax is sent to a D range calculation circuit 106. The D range calculation circuit 106 calculates the maximum luminance level of the photographed subject on the basis of the photoelectric transfer characteristics of the secondary photosensitive pixel described with respect to FIG. 8 and from information about the maximum value Gmax and calculates the maximum dynamic range required for recording that subject.

In the present example, setting information for specifying the maximum reproduction dynamic range in percent terms can be inputted by a user through a predetermined user interface (which will be described later). The D range selection information 107 specified by the user is sent from the CPU 56 to the D range calculation circuit 106. The D range calculation circuit 106 determines a dynamic range used for recording based on a dynamic range obtained through analysis of the captured image data and the D range selection information specified by the user.

If the maximum dynamic range obtained from the captured image data is equal to or smaller than the D range indicated by the D range selection information 107, the dynamic range obtained from the captured image data is used. If the maximum dynamic range obtained from the captured image data is greater than the D range indicated by the D range selection information, the D range indicated by the D range selection information is used.

The gamma factor of the gamma correction circuit 104 for low-sensitivity image data is controlled according to the D range determined in the D range calculation circuit 106.

The image data outputted from the gamma correction circuit 104 undergoes a synchronization process and YC conversion in the synchronization circuit 108. Luminance and color-difference signals (Y Cr Cb) generated in the synchronization circuit 108 are sent to correction circuits 109, where corrections such as edge enhancement and color-difference matrix processing are applied to the signals. The low-sensitivity image data to which required corrections have been applied in the correction circuits 109 is compressed in a JPEG compression circuit 110 and stored in the storage medium 52 as an image file separate from the high-sensitivity image data file.

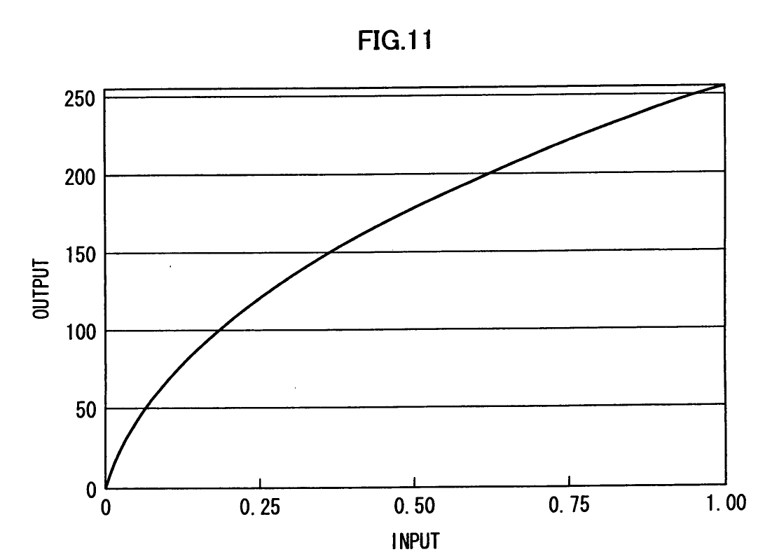

For high-sensitivity image data, image design is performed in conformity to the sRGB color specification, which is a typical specification for consumer displays. FIG. 11 shows photoelectric transfer characteristics for the sRGB color space. Providing the transfer characteristics as shown in FIG. 11 in an imaging system can reproduce a good image in terms of luminance when an image is reproduced by using a typical display.

Recently, color reproduction design for an extended color space larger than an sRGB color space has been used in the field of printing.

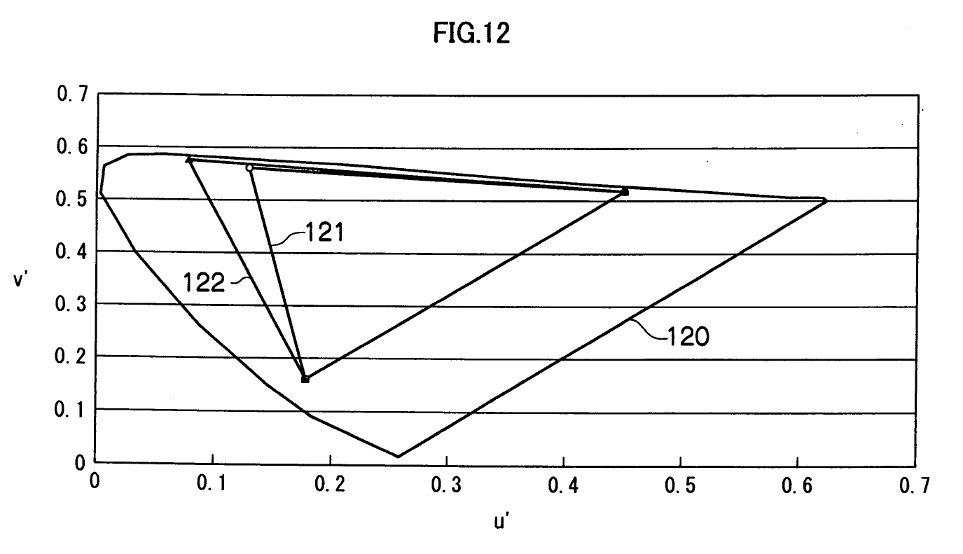

FIG. 12 shows examples of sRGB and extended color spaces. The region enclosed with the U-shaped line designated by reference numeral 120 is a human-perceivable color area. The region in the triangle designated by reference numeral 121 is a color reproduction gamut that can be reproduced in an sRGB color space. The region in the triangle designated by reference numeral 122 is a color reproduction gamut that can be reproduced in an extended color space. Different color regions can be reproduced by changing linear matrix values (matrix values in the linear matrix circuits 92, 102 described with reference to FIG. 10).

According to the present embodiment, not only high-sensitivity image data but also low-sensitivity image data obtained in the same exposure is used in image processing to extend a color reproduction gamut and luminance reproduction gamut to produce more preferable images in an application such as printing that uses a color space other than sRGB. Different gammas can be provided for different reproduction gamuts to produce different images according to different dynamic ranges.

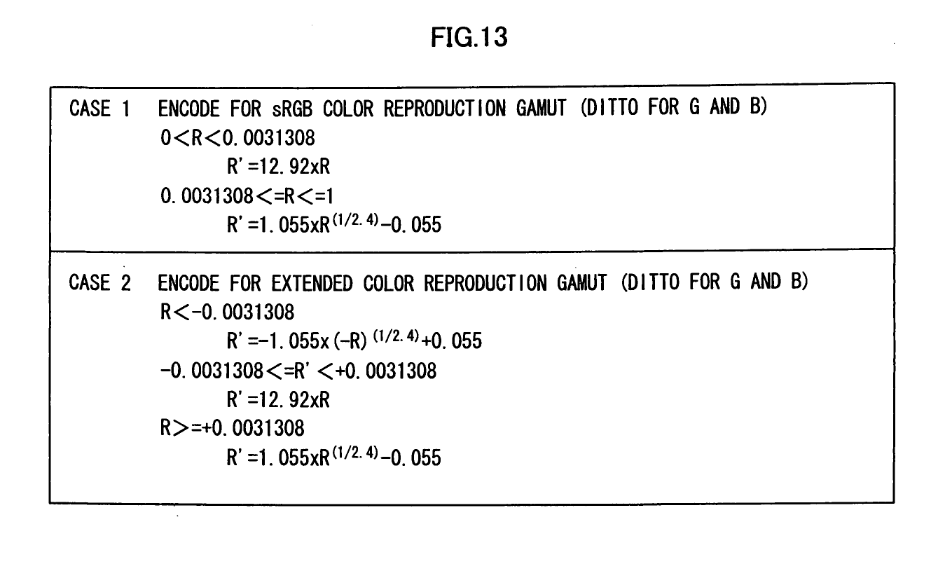

FIG. 13 shows encode expressions for an sRGB color reproduction gamut and an extended color reproduction gamut. A file can be generated according to a reproducible luminance gamut by using an encode condition that supports a negative value and a value equal to or greater than one, for example, as shown in the lower part (Case 2) of FIG. 13. For low-sensitivity image data, signal processing is performed to generate a file in accordance with encode conditions corresponding to the extended reproduction gamut.

For highlight information, the bit depth is important since it includes subtle information. Therefore, preferably, data corresponding to sRGB is recorded as 8-bit data and data corresponding to an extended reproduction gamut is recorded using a larger number of bits, for example 16 bits.

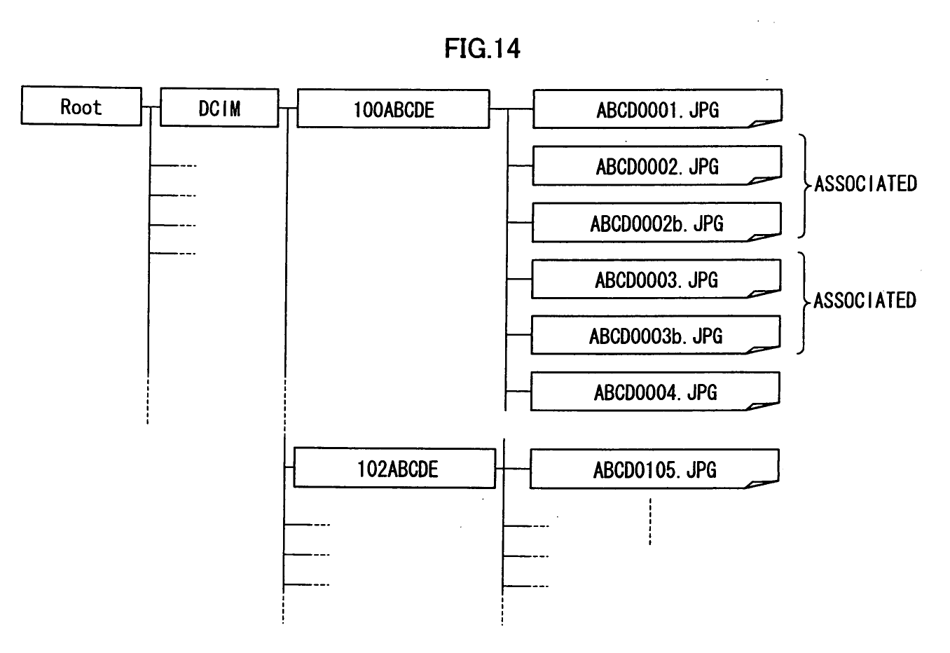

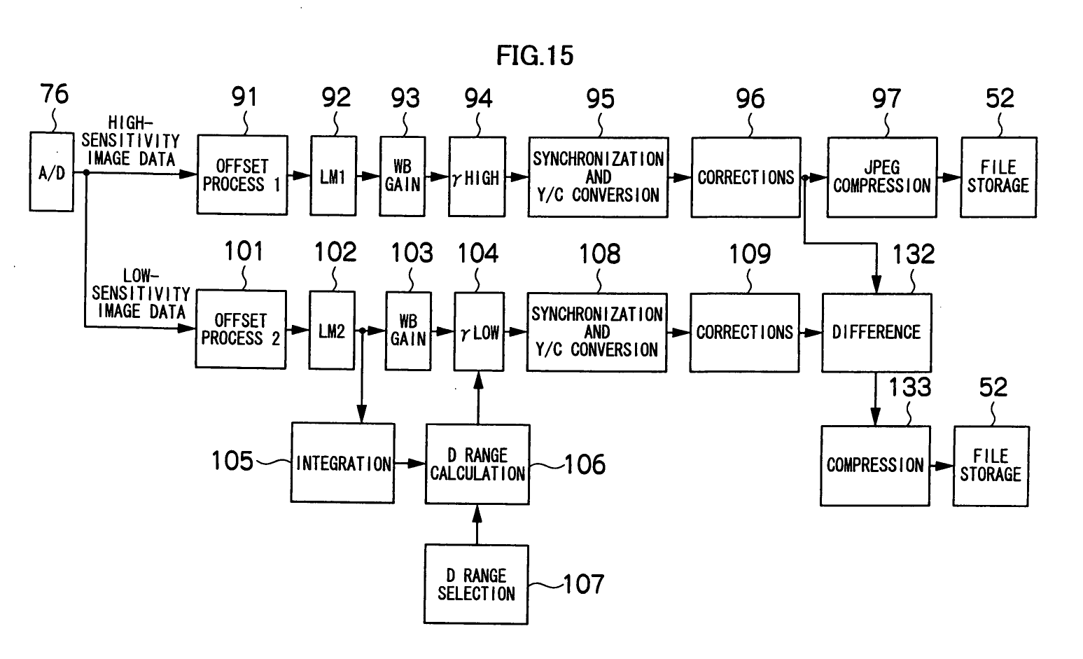

FIG. 14 shows an example of a directory (folder) structure of the storage medium 52. The camera 50 has the capability of storing image files in conformity to DCF standard (Design rule for Camera File system standard (a unified storage format for digital camera specified by Japan Electronic Industry Development Association (JEIDA))).

As shown in FIG. 14, provided immediately under the root directory is a DCF image root directory with the directory name “DCIM.” At least one DCF directory exists immediately under the DCF image root directory. A DCF directory stores image files, which are DCF objects. A DCF directory name is defined with a three-digit directory number followed by five free characters (eight characters in total) in compliance with the DCF standard. A DCF directory name may be automatically generated by the camera 50 or may be specified or changed by a user.

An image file generated in the camera 50 is given a filename automatically generated following the naming convention of the DCF standard and stored in a DCF directory specified or automatically selected. A DCF filename following the DFC naming convention consists of four free characters followed by four-digit file number.

Two image files generated from high-sensitivity image data and low-sensitivity image data obtained in wide-dynamic-range recording mode are associated with each other and stored. For example, one file generated from high-sensitivity image data (a normal file that supports a typical reproduction gamut; hereinafter called a standard image file) is named “ABCD****.JPG” (where “****” is a file number) according to the DFC naming convention. The other file generated from low-sensitivity image data obtained during the same shot as that of high-sensitivity image data (a file that supports an extended reproduction gamut; hereinafter called an extended image file) is named “ABCD****b.JPG,” with “b” added to the end of filename (8-character string excluding “.JPG”) of the standard image file. Storing files with their names associated with each other allows a file suitable for output characteristics to be selected and used.

In another example of associating file names with each other, a character such as “a” may be added to the end of the filename of a standard image file as well. An extended image file can be differentiated from the standard image file by adding a different character string to the end of the file number of the standard image file than that of the extended image file. In another implementation, the free characters preceding a file number may be changed. In yet another implementation, an extension different from the extension of a standard image file may be used. Two files can be associated with each other by using the same file number at least.

The storage format of an extended image file is not limited to the JPEG format. As shown in FIG. 12, most of colors in the extended color space are the same as those in the sRGB color space. Accordingly, if a captured image is encoded into two different images, one for the sRGB color space and one for the extended color space, and a difference between the two images is obtained, then almost all pixels in the image will have a value of 0. Therefore, the extended color space can be supported and memory can be saved by applying Huffman compression, for example, to the difference between the images and storing one of the images as an sRGB image file for a standard device and the other as a difference image file.

FIG. 15 shows a block diagram of an embodiment in which low-sensitivity image data is stored as a difference image as described above. Components in FIG. 15 that are the same as or similar to those in FIG. 10 are labeled with the same reference numerals and the description of which will be omitted.

An image generated from high-sensitivity image data and an image generated from low-sensitivity image data are sent to a difference image generation circuit 132, where a difference image between the images is generated. The difference image generated in the difference image generation circuit 132 is sent to a compression circuit 133, where it is compressed by using a predetermined compression technology different from JPEG. The file of the compressed image data generated in the compression circuit 133 is stored in a storage medium 52.

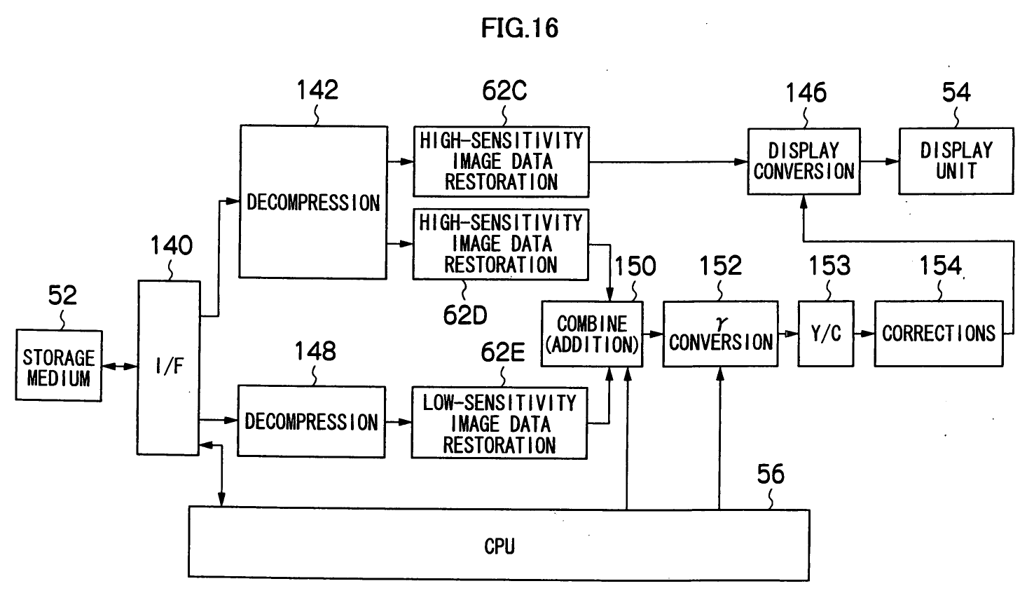

FIG. 16 is a block diagram showing a configuration of a reproduction system. Information stored in the storage medium 52 is read through a media interface 140. The media interface 140 is connected to the CPU 56 through a bus and performs signal conversion required for passing read and write signals to and from the storage medium 52 according to instructions from the CPU 56.

Compressed standard image file data read from the storage medium 52 is decompressed in a decompressor 142 and loaded into a high-sensitivity image data restoration area 62C in the memory 62. The decompressed high-sensitivity image data is sent to a display conversion circuit 146. The display conversion circuit 146 includes a size reducer for resizing an image to suit the resolution of the display unit 54 and a display signal generator for converting a display image generated in the size reducer into a predetermined display signal format.

The signal converted into the predetermined display format in the display conversion circuit 146 is outputted to the display unit 54. Thus, a reproduction image is displayed on the display unit 54. Typically, only the standard image file is reproduced and displayed on the display unit.

When an extended image file associated with the standard image file is used to generate an image in a wide reproduction gamut, RGB high-sensitivity image data is restored from data obtained by decompressing the standard image file and the restored data is stored in a high-sensitivity image data restoration area 62D in the memory 62.

Then the extended image file is read from the storage medium 52, decompressed in the decompressor 148, restored to the RGB low-sensitivity image data, and the restored data is stored in a low-sensitivity image data restoration area 62E in the memory 62. The high-sensitivity image data and the low-sensitivity image data thus stored in the memory 62 are read out and sent to a combining unit (image addition unit) 150.

The combining unit 150 includes a multiplier for multiplying high-sensitivity image data by a factor, another multiplier for multiplying low-sensitivity image data by a factor, and an adder for adding (combining) multiplied high-sensitivity image data and the multiplied low-sensitivity image data together. The factors (which represent the ratio of addition) multiplying high-sensitivity image data and low-sensitivity image data are set and can be changed by the CPU 56.

Signals generated in the combining unit 150 are sent to a gamma converter 152. The gamma converter 152 refers to data in the ROM 60 under the control of the CPU 56 and converts the input-output characteristics to desired gamma characteristics. The CPU 56 controls the converter 152 to change gamma characteristics to suit a reproduction gamut that will be provided while the image is displayed. The gamma corrected image signals are sent to a YC converter 153, where they are converted from RGB signals to luminance (Y) and color-difference (Cr, Cb) signals.

The luminance/color-difference signals (YCr Cb) generated in the YC converter 153 are sent to correction units 154. Required corrections such as edge enhancement (aperture correction) and color correction using a color-difference matrix are applied to the signals in the correction units 154 to generate a final image. The final image data thus generated is sent to a display conversion circuit 146 and converted into display signals and then outputted to the display unit 54.

While the example in which the image is reproduced and displayed on the display unit 54 built in the camera 50 has been described with reference to FIG. 16, the image can be reproduced and displayed on an external image display device. Furthermore, a process flow similar to the one shown in FIG. 16 can be implemented by using a personal computer on which an image viewing application program is installed, a dedicated image reproduction device or a printer to reproduce a standard image and an image compliant with an extended reproduction gamut.

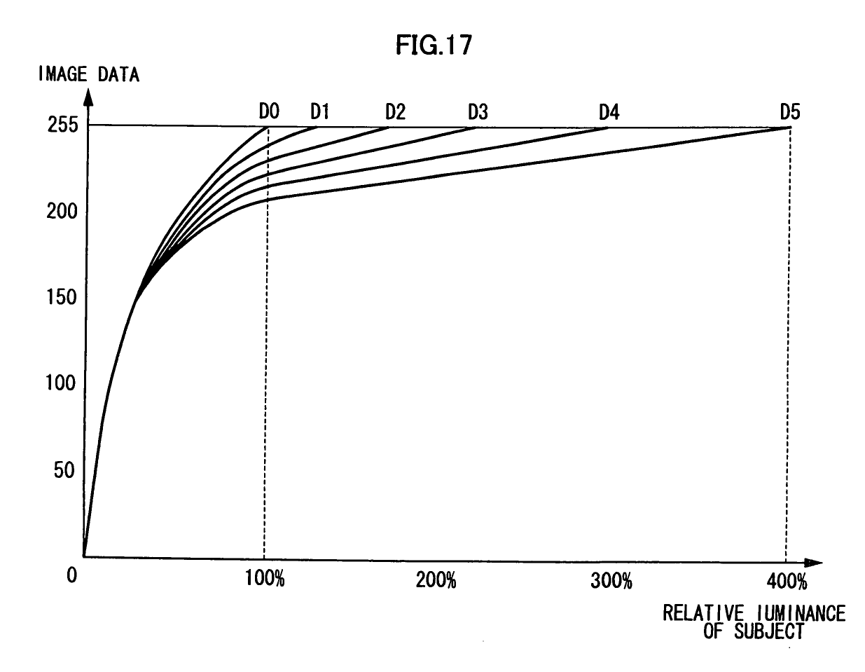

FIG. 17 shows a graph of the relationship between the level of a final image (compound image data) generated by combining high-sensitivity image data and low-sensitivity image data and the relative luminance of a subject.

The relative luminance of the subject is represented in percentage relative to the subject luminance at which the high-sensitive image data becomes saturated. While the image data is represented with 8 bits (0 to 255) in FIG. 17, the number of bits is not limited to this.

The dynamic range of the compound image is set through a user interface. In this example, it is assumed that one of six levels of dynamic range, D0 to D5, can be set. Because, substantially, human perception works on a log scale, the reproduction dynamic range may be changed stepwise like, 100%-130%-170%-220%-300%-400%, for example, in terms of relative luminance of the subject so that functions of the log (logarithm) become substantially linear.

The number of levels of dynamic range is not limited to six. Any number of levels can be designed and continuous settings (no levels) are also possible.

The gamma factor of the gamma circuit, image combination parameters used for addition, and the gain factor of the color-difference signal matrix circuit are controlled according to the setting of dynamic range. Stored in a non-volatile memory (ROM 60 or EEPROM 64) in the camera 50 is table data specifying parameters and factors corresponding to the available levels of dynamic range.

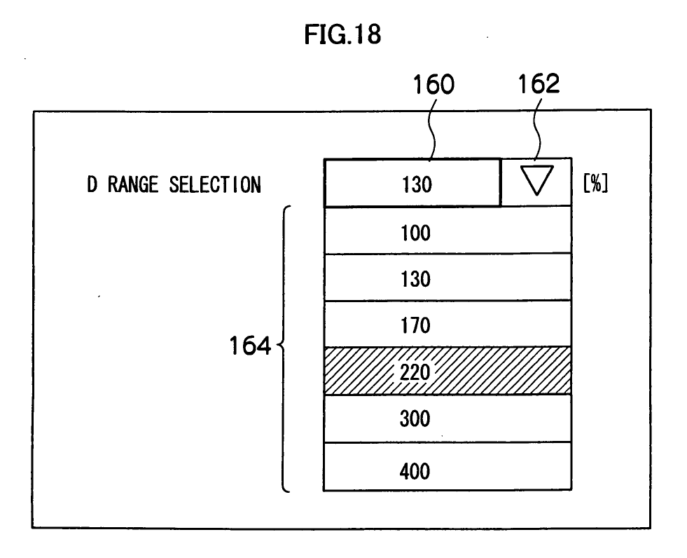

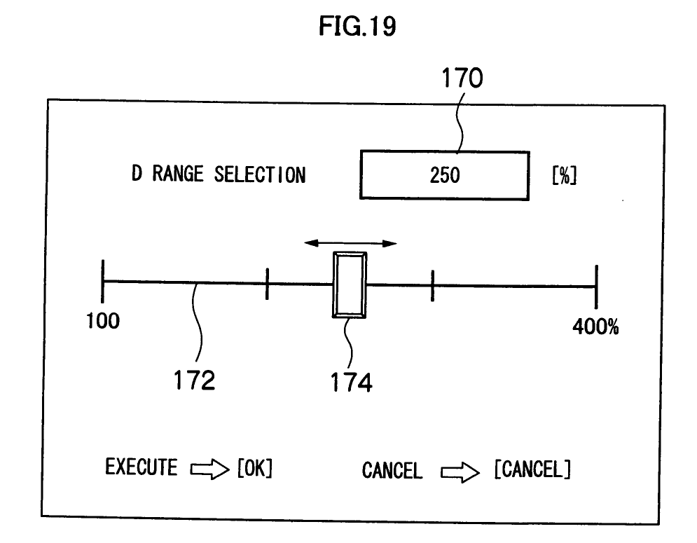

FIGS. 18 and 19 show examples of the user interface used for selecting a dynamic range. In the example shown in FIG. 18, an entry box 160 is displayed in which a dynamic range can be specified in a dynamic range setting screen reached from a menu screen. When a pull-down menu button 162 displayed to one side of the entry box 160 is selected through the use of a given operating device such as an arrow pad, a pull-down menu 164 is displayed as shown that indicates selectable values of dynamic range (relative luminance of subject).

A desired level of dynamic range is selected from the pull-down menu 164 with the arrow pad and an OK button is pressed, whereby that dynamic range is set.

In another example shown in FIG. 19, an entry box 170 and a D range parameter axis 172 are displayed in a dynamic range setting screen. By using an operating device such as an arrow pad to move a slider 174 along a D range parameter axis 172, any dynamic range within a range from 100% to 400% at maximum can be specified. As the slider 174 is moved, the set value of dynamic range in the entry box 170 is changed accordingly. When a desired set value is displayed, the OK button is pressed as indicated at the bottom of the screen to confirm (cause to execute) the setting. If the cancel button is pressed, the setting is canceled and the previous setting is restored.

While a dynamic range is selected on the screen of the display unit 54 in the example described with reference to FIGS. 18 and 19, the selection may be made by using other operating components such as a dial switch, slide switch, or a pushbutton switch in another implementation.

Because different dynamic ranges are required by different scenes, a captured image is analyzed to automatically set an appropriate dynamic range in another implementation. Yet another implementation is possible in which an appropriate dynamic range is automatically selected according to shooting mode such as portrait mode and night view mode.

Dynamic range information about up to what percentage of information has been recorded is stored in the header of the file of the image data. The dynamic range information may be stored in either standard and extended image files or one of the files.

Adding dynamic range information to an image file allows an image output device such as a printer to generate an optimum image by reading the information and altering values used for processing such as image combination, gamma conversion, and color correction.

Even in print applications, images that reproduce soft skin tones with fine gradation are preferred for portraits. Therefore, it is useful that an extended image is generated that is fit for the type of photograph, such as an advertising photograph, portrait, or indoor or outdoor shooting photograph. To achieve this, the user interface is provided in a camera 50 that allows a user to specify a luminance reproduction gamut for an extended image according to intended use or shooting conditions, as described with respect to FIGS. 18 and 19.

Operations of a camera 50 configured as described above will be described below.

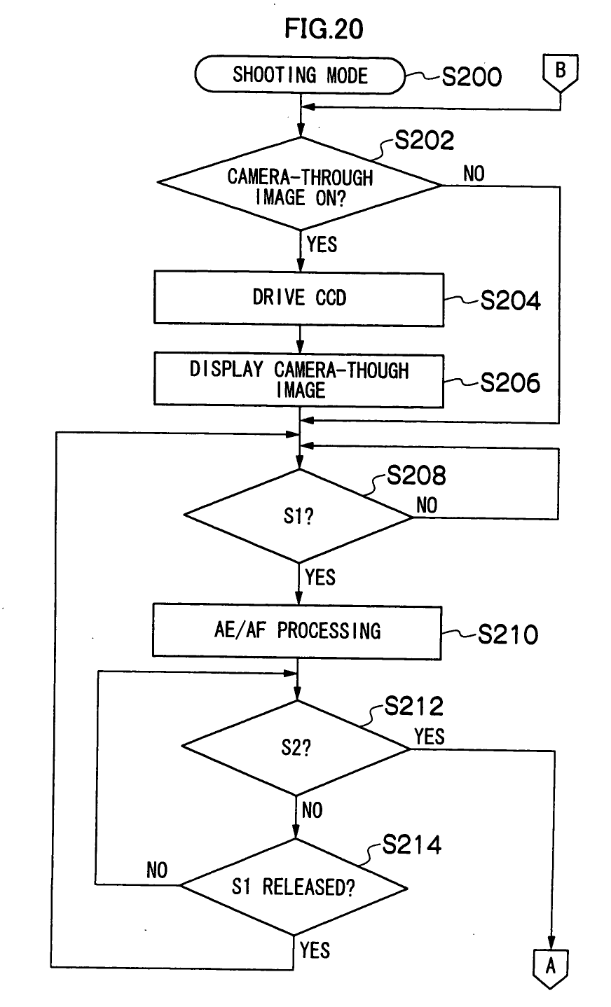

FIGS. 20 to 22 are flowchart of a procedure for controlling the camera 50. When the camera is powered on in shooting mode or is placed in shooting mode from reproduction mode, the control flow shown in FIG. 20 starts.

When the shooting mode starts (step S200), the CPU 56 determines whether or not mode for displaying a camera-through image on the display unit 54 is selected (step S202). If mode for turning on the display unit 54 (camera-through image On mode) is selected on a screen such as a setup screen when the shooting made starts, the process proceeds to step S204, where power is supplied to the imaging system including the CCD 20 and the camera becomes ready for taking pictures. The CCD 20 is driven in predetermined cycles in order to continuously shoot for displaying camera-through images.

The display unit 54 of the camera 50 in this example uses NTSC-based video signal and its frame rate is set to 30 frames/second (1 field=1/60 seconds because 1 frame consists of 2 fields). Because the camera 50 uses a technology that displays two fields for each image, the display is updated every 1/30 seconds. To update image data on one screen in this cycle, the cycle of the vertical drive (VD) pulse of the CCD 20 in camera-through mode is set to 1/30 seconds. The CPU 56 provides a control signal for CCD drive mode to a timing generator 82 to generate a CCD drive signal. Thus, the CCD 20 starts continuous shooting and camera-through images are displayed on the display unit 54 (step S206).

While camera-through images are being displayed, the CPU 56 listens for a signal input from the shutter button to determine whether or not the S1 switch is turned on (step S208). If the S1 switch is in the off state, the operation at step S208 loops and the camera-through image display state is maintained.

If the camera-through image mode is set to OFF (non-display) at step S202, steps S204 to S206 are omitted and the process proceeds to step S208.

When the shutter button is pressed by a user and an instruction to prepare for shooting is provided (the CPU 56 detects the S1=ON state), the process proceeds to step S210 where AE and AF processes are performed. The CPU 56 changes the CCD drive mode to 1/60 seconds. Accordingly, the cycle for capturing images from the CCD 20 becomes shorter to enable AE and AF processes to be performed faster. The CCD drive cycle set here is not limited to 1/60 seconds. It can be set to any appropriate value such as 1/120 seconds. Shooting conditions are set by the AE process and focus adjustment is performed by the AF process.

Then, the CPU 56 determines whether or not a signal is input from the S2 switch of the shutter button (step S212). If the CPU 56 determines at step S212 that the S2 switch is not turned on, it determines whether or not the S1 switch is released (step S214). If it is determined at step S214 that the switch S1 is released, the process returns to step S208 where the CPU 56 waits until a shooting instruction is inputted.

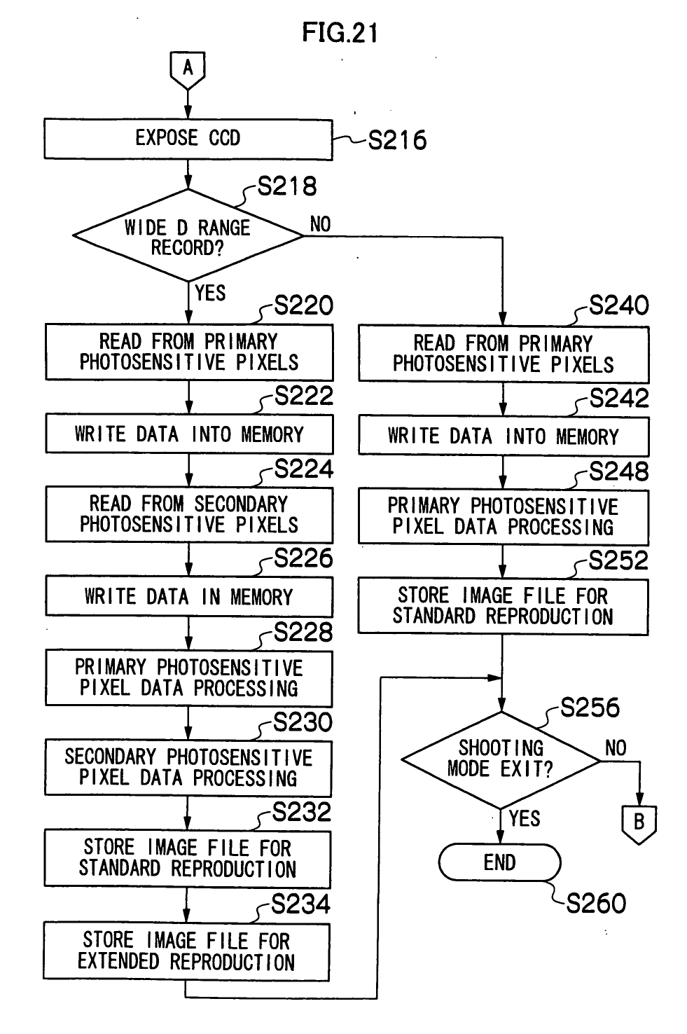

On the other hand, if it is determined at step S214 that the S1 switch is not released, the process returns to step S212 where the CPU 56 waits for an S2=ON input. When an S2=ON input is detected at step S212, the process proceeds to step S216 shown in FIG. 21 where shooting (a CCD exposure) is started in order to capture an image to record.

Then, it is determined whether or not a wide dynamic range recording mode is set, and the process is controlled according to the set mode. If a wide dynamic range recording mode is selected through a given operating device such as a D range extension mode switch, signals are read from primary photosensitive pixels 21 first (step S220) and the image data (primary photosensor data) is written in a first image memory 62A (step S222).

Then, signals are read from secondary photosensitive pixels 22 (step S224) and the image data (secondary photosensor data) is written in a second image memory 62B (step S226).

Required signal processing is applied to the primary photosensor data and the secondary photosensor data as described with respect to FIG. 10 or 15 (steps S228 and S230). An image file for standard reproduction which is generated from the secondary photosensor data is associated with an image file for extended reproduction which is generated from the secondary photosensor data and the files are stored in a storage medium 52 (steps S232 and S234).

On the other hand, if it is determined at step S218 that a mode in which wide dynamic range recording is not performed is set, signals are read only from the primary photosensitive pixels 21 (step S240). The primary photosensor data is written in the first image memory 62A (step S242), then subsequent processing is applied to the primary photosensor data (step S248). Here, required signal processing described with respect to FIG. 10 is applied to the data and then a process for generating an image from the primary photosensor data is performed. Image data generated at step S248 is stored in the storage medium 52 in a predetermined file format (step S252).

After the completion of the storage operation at step S234 or step S252, the process proceeds to step S256 where it is determined whether or not an operation for exiting shooting mode has been performed. If the operation for exiting shooting mode has been performed, the shooting mode is completed (step S260). If the operation for exiting shooting mode has not been performed, the shooting mode is maintained and the process will return to step S202 in FIG. 20.

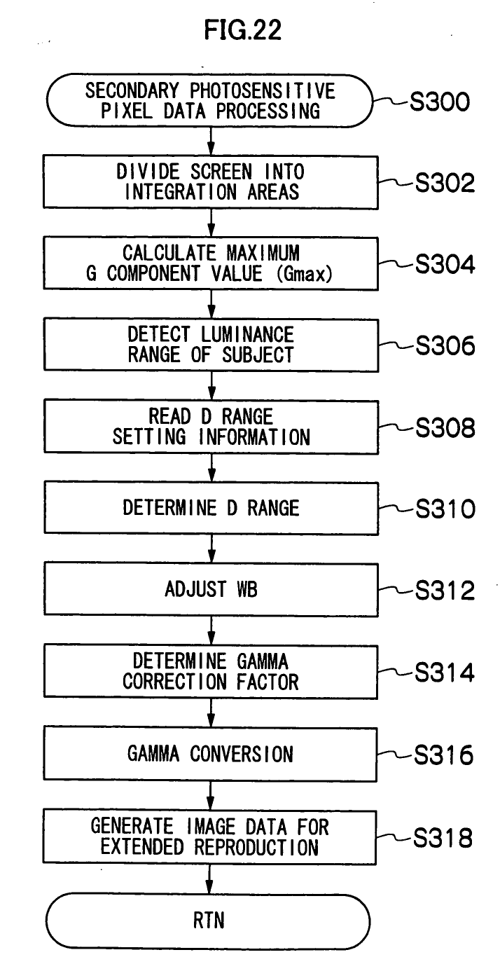

FIG. 22 is a flowchart of a subroutine concerning secondary photosensitive pixel data processing shown at step S230 in FIG. 21. As shown in FIG. 22, when the secondary photosensitive pixel data processing is started (step S300), first a screen is divided into a number of integration areas (step S302), the average of G (green) components in each area is calculated and the maximum value of the G components (Gmax) is obtained (step S304).

A luminance range of a photographed subject is detected from the area integration information thus obtained (step S306). Dynamic range setting information set through a predetermined user interface (setting information indicating to what extent (in percentage term) the dynamic range is to be extended) is read in (step S308). A final dynamic range is determined (step S310) based on the subject luminance range detected at step S306 and the dynamic range setting information read at step S308. For example, the dynamic range is automatically determined according to the luminance range of the photographed subject up to a set D range indicated by the dynamic range setting information.

Then, the signal level of each color channel is adjusted by white balancing (S312). Parameters such as a gamma correction factor and a color correction factor are also determined based on the table data according to the determined final dynamic range (step S314).

Gamma conversion and other processes are performed according to the parameters determined (step S316) and image data for extended reproduction is generated (step S318). After the completion of step S318, the process returns to the flowchart shown in FIG. 21.

It is preferable that reproduction ranges can be selected when an image stored in a storage medium 52 is reproduced as described above so that switching between an image for standard reproduction and an image for extended reproduction can be performed as required to output either of them. In this case, when an extended reproduction image is reproduced, the gamma of the image is adjusted such that the brightness of the image of a main subject becomes substantially the same as that of the image for standard reproduction and thereby provides gradation to a bright portion. Thus, a difference between the bright portion of the standard reproduction image and that of the extended reproduction image can be seen without affecting the impression of the main subject portion.

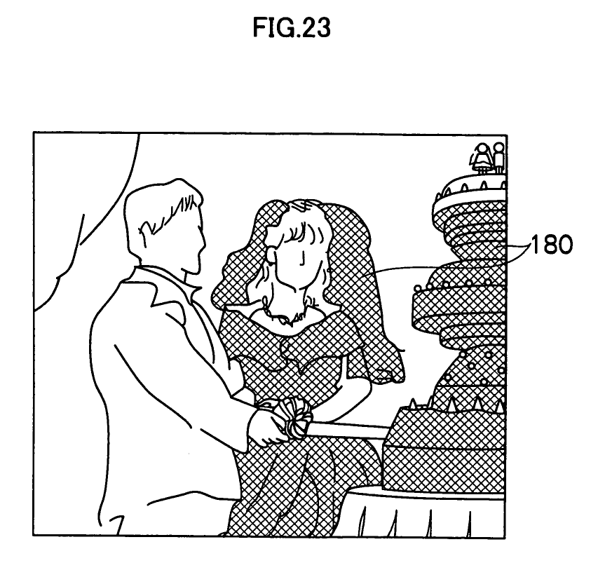

Furthermore, when a standard reproduction image is displayed on the display unit 54, it is determined whether or not information about extended reproduction is stored, and if it is recorded (an extended reproduction image file associated with the standard reproduction image exists), a portion corresponding to a difference between the images is highlighted 180 as shown in FIG. 23.

For example, a difference between high-sensitivity image data and low-sensitivity image data is calculated and a portion having a positive difference value (a portion that includes extended reproduction information for extending a reproduction gamut) is displayed in a special manner (highlighted). Highlighting may be implemented in any form, such as flashing in a portion to be highlighted, enclosing the portion with a line, changing the brightness or color tone of the portion, or any combinations of these, that enables a highlighted portion to be distinguished from the remaining regions, and not limited to specific display form.

Using associated, extended reproduction information to visualize a portion that can be reproduced in finer detail as described above allows a user to see extendibility of image reproduction.

While a digital camera has been described by way of example in the above embodiments, the applicable scope of the present invention is not limited to this. The present invention can be applied to other camera apparatuses having electronic image capturing capability, such as a video camera, DVD camera, cellphone with camera, PDA with camera, and mobile personal computer with camera.

The image reproduction device described with respect to FIG. 16 can be applied to an output device such as a printer and image viewing device as well. In particular, the display conversion circuit 146 and the display unit 54 in FIG. 16 can be replaced with an image generator for outputting images, such as a print image generator, and an output unit, such as a printing unit, for outputting final images generated in the image generator to provide quality images using extended reproduction information.

What is claimed is:

1. An image processing apparatus comprising:
an image display device for displaying an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control device for switching between first image information obtained from said primary photosensitive pixels and second image information obtained from said secondary photosensitive pixels to cause said image display device to display said first or second image information.

2. An image processing apparatus comprising:
an image display device for displaying an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control device which causes said image display device to display first image information obtained from said primary photosensitive pixels and highlight an image portion the reproduction gamut of which is extended by said second image information with respect to the reproduction gamut of said first image information, on the display screen of said first image information.

3. The image processing apparatus according to claim 1, wherein said image pickup device has a structure in which each photoreceptor cell is divided into a plurality of photoreceptor regions including at least said primary photosensitive pixel and said secondary photosensitive pixel, a color filter of the same color component is disposed over each photoreceptor cell for said primary photosensitive pixel and said secondary photosensitive pixel in the photoreceptor cell, and one micro-lens is provided for each photoreceptor cell.

4. The image processing apparatus according to claim 2, wherein said image pickup device has a structure in which each photoreceptor cell is divided into a plurality of photoreceptor regions including at least said primary photosensitive pixel and said secondary photosensitive pixel, a color filter of the same color component is disposed over each photoreceptor cell for said primary photosensitive pixel and said secondary photosensitive pixel in the photoreceptor cell, and one micro-lens is provided for each photoreceptor cell.

5. An image processing method comprising:
an image display step of displaying on an image display device an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control step of switching between first image information obtained from said primary photosensitive pixels and second image information obtained from said secondary photosensitive pixels to cause said image display device to display said first or second image information.

6. An image processing method comprising:
an image display step of displaying on an image display device an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control step of causing said image display device to display first image information obtained from said primary photosensitive pixels and highlight an image portion the reproduction gamut of which is extended by said second image information with respect to the reproduction gamut of said first image information, on a display screen for said first image information.

7. An image processing program that causes a computer to implement:
an image display function of displaying on an image display device an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control function of switching between first image information obtained from said primary photosensitive pixels and second image information obtained from said secondary photosensitive pixels to cause said image display device to display said first or second image information.

8. An image processing program that causes a computer to implement:
an image display function of displaying on an image display device an image obtained by an image pickup device which has a structure in which a large number of primary photosensitive pixels having a narrower dynamic range and higher sensitivity and a large number of secondary photosensitive pixels having a wider dynamic range and lower sensitivity are arranged in a given arrangement and image signals can be obtained from said primary photosensitive pixels and said secondary photosensitive pixels at one exposure; and
a display control function of causing said image display device to display first image information obtained from said primary photosensitive pixels and highlight an image portion the reproduction gamut of which is extended by said second image information with respect to the reproduction gamut of said first image information, on a display screen for said first image information.
